(19) United States
(12) Patent Application Publication
(10) Pub. No.: US 2018/0369975 A1
(43) Pub. Date: Dec. 27, 2018

(54) APPARATUS AND METHOD TO EXTEND CUTTING TOOL LIFE

(71) Applicant: RESEARCH & TECHNOLOGY SOLUTIONS LLC, GREENVILLE, SC (US)

(72) Inventor: Charles Anthony, Greenville, SC (US)

(73) Assignee: RESEARCH & TECHNOLOGY SOLUTIONS, LLC, GREENVILLE, SC (US)

(21) Appl. No.: 16/017,219

(22) Filed: Jun. 25, 2018

Related U.S. Application Data
(60) Provisional application No. 62/523,839, filed on Jun. 23, 2017.

(51) Int. Cl. B23Q 11/10; B23C 9/00

(52) U.S. Cl. CPC B23Q 11/10; B23C 9/005

(57) ABSTRACT

A CNC apparatus and method of operating the CNC apparatus is provided in which the CNC machine additionally controls positionable air nozzles that can be used to provide a customized delivery of air to the cutting tool and substrate thereby minimizing damage and wear to the tool and preventing thermal damage of the substrate.

### RELATED APPLICATIONS

This application claims the benefit of U.S. Application Ser. No. 62/523,839 filed on Jun. 23, 2017 and which is incorporated herein by reference

### FIELD OF THE INVENTION

This invention is directed towards an apparatus and process for improving, the cutting tool life of a cutting tool used on a CNC machine and provides a more efficient operation of the CNC machine.

### BACKGROUND OF THE INVENTION

CNC cutting machines are widely used to machine parts from a variety of substrates including metals and hard plastics. An industry-wide problem is that as the cutting tool is cutting, localized high temperatures are generated which can degrade the cutting tool and may damage the substrate.

For some applications, CNC machines will employ a chemical coolant that is used in proximity to the cutting edge of the cutting tool. However, the current use of coolant results in a pattern of heating and cooling cycles which can lead to thermal cracking of the cutting edge and may further damage the substrate. The coolant currently used is directed along stationary lines which mean that at some point, the cutting tool and substrate are in a less than desired orientation relevant to the coolant. Accordingly, the cutting tool and substrate will reach elevated temperatures from the substrate removal process and then is suddenly cooled when once again exposed to the coolant.

An additional problem is that chips generated from the substrate removal process can stick to a heated portion of the substrate or the cutting tool and interfere with the substrate removal operation and may lead to cutting tool breakage. This is a particular problem when coolant is used because coolant causes the chips to become tacky and thus more prone to stick together and the use of a coolant will add to the weight of the chips. When the substrate is cut with air, the chips are lighter and are less prone to stick together or bind to the substrate.

It is known in the art to use a coolant that passes through the spindle tool holder be externally supplied and directed toward the tool and or tool holder. However, a fixed design employed by those types of apparatuses has inherent problems. One, the material will often block the tool from receiving the coolant. Additionally, the tool holder is spinning at high rate of speed when the coolant is being applied, to the cutting tool. The coolant, passing through the rotating tool holder, moves in an outward pattern due to centrifugal forces and does not interact with the cutting edge of the tool in an effective manner. Any static positioned coolant line will at some point during a machining process, will not deliver adequate cooling flow in terms of either the volume of coolant or a desired direction of coolant flow.

When chemical coolants have been used, the disadvantages include the expense of the coolants, the environmental/disposal issues of using coolants, and the fact that for some substrates, the chips and other scrap material, once exposed to coolant, is less useful for scrap recycling.

Accordingly, there is room for variation and improvement within the art.

### SUMMARY OF THE INVENTION

It is one aspect of at least one of the present embodiments to provide for a pressurized airflow that can be moved to maintain a desired vector/angle of airflow relative to the cutting tool which enables the substrate and the tool to dissipate heat.

It is a further aspect of at least one embodiment of the present invention to provide for an apparatus and process that will remove cut chips from the cutting tool/substrate environment.

It is a further aspect of at least one embodiment of the present invention to provide for an apparatus and process that provides for a continuous airflow that is rotatably adjusted and will maintain a proper orientation relative to the cutting tool and substrate of a CNC machine, the pressurized airflow allowing cooling of both the cutting tool and substrate as well as providing for the effective removal of chips from the cutting tool/substrate interface.

It is a further aspect of at least one embodiment of the present invention to provide for an apparatus and process in which a directed air device is rotatably mounted to at least one of a CNC machine spindle, a table within the CNC machine, or placement within a separate device, all of which allow for the programmed control of the airflow direction, angle, and velocity relative to the cutting tool/substrate interface.

It is a further aspect of at least one embodiment of the present invention to provide for an apparatus and process in which a servo motor, responsive to the CNC machine, is used to direct a pressurized airflow at a desired angle and velocity relative to a cutting tool, movement of the one or more air nozzles being in response to movement of the cutting tool relative to the substrate.

It is a further aspect of at least one embodiment of the present invention to a process of operating a CNC machine comprising the steps of: providing a substrate to be cut; engaging the substrate with a rotating cutting tool controlled by a CNC machine, the position of the cutting tool axis and or vector direction relative to the substrate changing as the substrate is cut; directing a stream of air from a nozzle to a leading edge of the rotary cutting tool; moving the nozzle in a synchronized manner relative to the movement of the cutting tool axis and or vector direction, thereby maintaining a continuous flow of air in a desired orientation to the cutting tool.

It is a further aspect of at least one embodiment of the present invention to a CNC machine comprising: a spindle; a tool holder; a cutting tool; and a rotatable housing supported by the CNC machine and in a position above the cutting tool; and at least one nozzle extending from the rotatable housing and adapted for directing a stream of air to an edge portion of a cutting tool.

It is a further aspect of at least one embodiment of the present invention to a tool head assembly for a CNC machine, displaceable along orthogonal x, y, and z-axes comprising: a support assembly; a tool carrier assembly supported on said support assembly having a rotatable tool axes and being displaceable relative to said support assembly; a rotatable housing supported by the support assembly and in a position above the tool carrier; and at least one nozzle extending from the rotatable housing and adapted for directing a stream of air to an edge portion of a cutting tool.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a perspective view of a prior art CNC cutting machine.

FIG. 2 is a prior art view of the CNC machine seen in FIG. 1 from an upper elevation.

FIGS. 3A and 3B illustrate a conventional static coolant delivery system in reference to a programmed tool path direction of a CNC machine.

FIGS. 4A and 4B show the cutting tool portion of a CNC machine on opposite sides of a cutting substrate.

FIGS. 5A-5D set forth air flow pathways of a coolant relative to a direction of travel of a cutting tool.

FIGS. 6A-6C illustrate portion of a Servo control mechanism relative to movement of coolant nozzles for a customized coolant flow directed to a cutting tool and a substrate.

FIG. 7 illustrates a desired direction of airflow from a coolant delivery pair of nozzles when the tool is moving the X direction relative to the cutting substrate.

FIGS. 8A-8D illustrates further positioning of coolant nozzles relative to a location of the cutting tool and the substrate.

FIG. 9 illustrates the ability to place nozzles in a plurality of locations relative to ports defined within an air delivery housing of the CNC machine.

FIG. 10 is a schematic view illustrating desired directions of coolant flow relative to the position of a cutting tool on a cutting substrate material.

FIG. 11 is a sectional view through a rotary union that facilitates the delivery of an air stream to a cutting tool.

### DETAILED DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in, the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

The use and technology surrounding CNC machines is well known. U.S. Pat. No. 7,853,351, which is incorporated herein by reference, describes a CNC machine and control processes for using the machine.

U.S. Pat. No. 6,932,547, which is incorporated herein by reference provides for a CNC machine having x, y, and z-axes control systems.

U.S. Pat. No. 9,981,356, which is incorporated herein by reference, describes a CNC machine and control system in which a cutting fluid is applied to a substrate using discharge nozzles in proximity to the cutting tool.

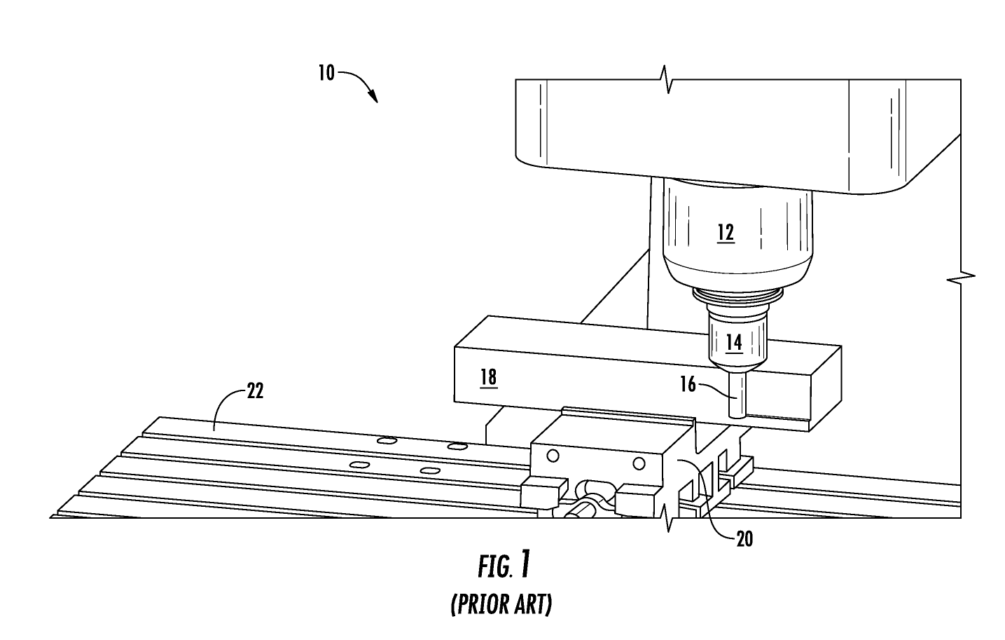

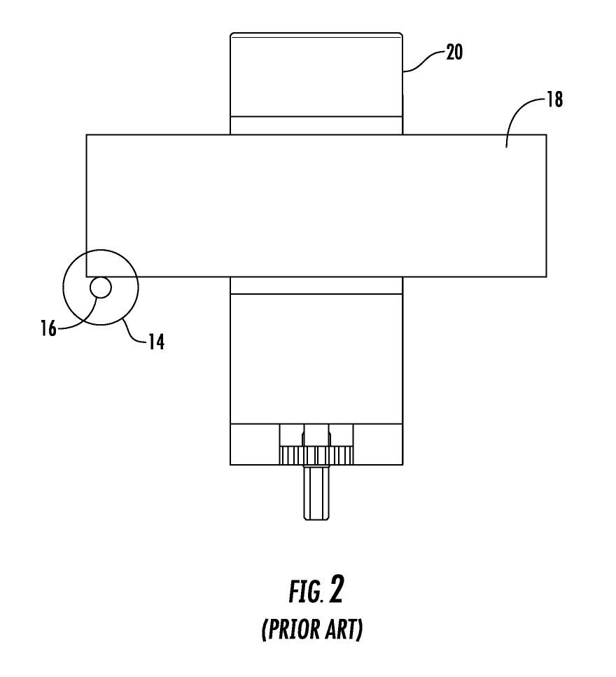

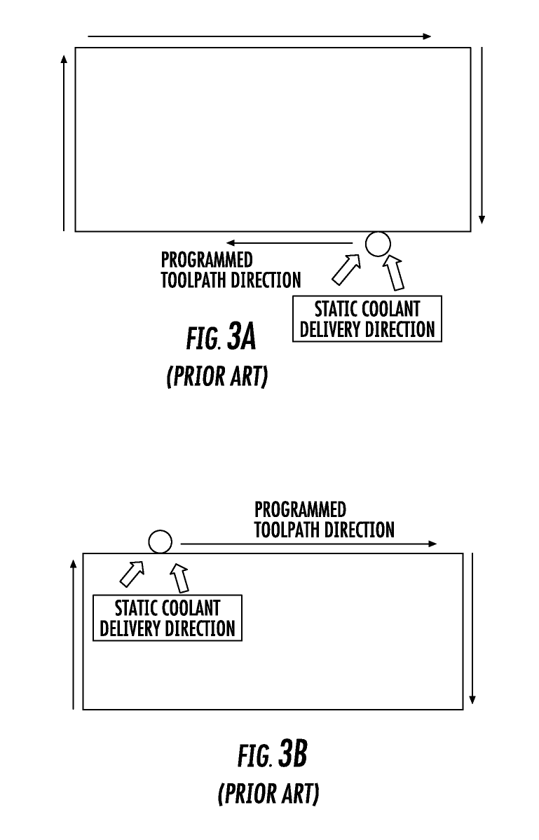

As set forth in FIGS. 1 and 2, a conventional set up for a CNC Machine is shown. The CNC machine 10 as a spindle 12 which is attached to a tool holder 14 for holding a cutting tool 16. The spindle 12 will service to rotate the cutting tool 16 such that it will engage a substrate 18. Substrate 18 is held within a vice 20 that is supported by a table 22. As seen in the prior art as referenced to FIGS. 3A & 3B, a traditional static delivery system of coolant or air is illustrated. The air/coolant flow seen in FIG. 3A will fail to provide proper cooling in a number of locations, such as in FIG. 3B, as the cutting tool rotates about the substrate. This results in damaging cycles of excessive heating and cooling that can generate cracking and metal fatigue to the cutting tool which shortens the cutting tool life. Further, the localized heating of the substrate by the cutting tool can be damaging to the desired end product.

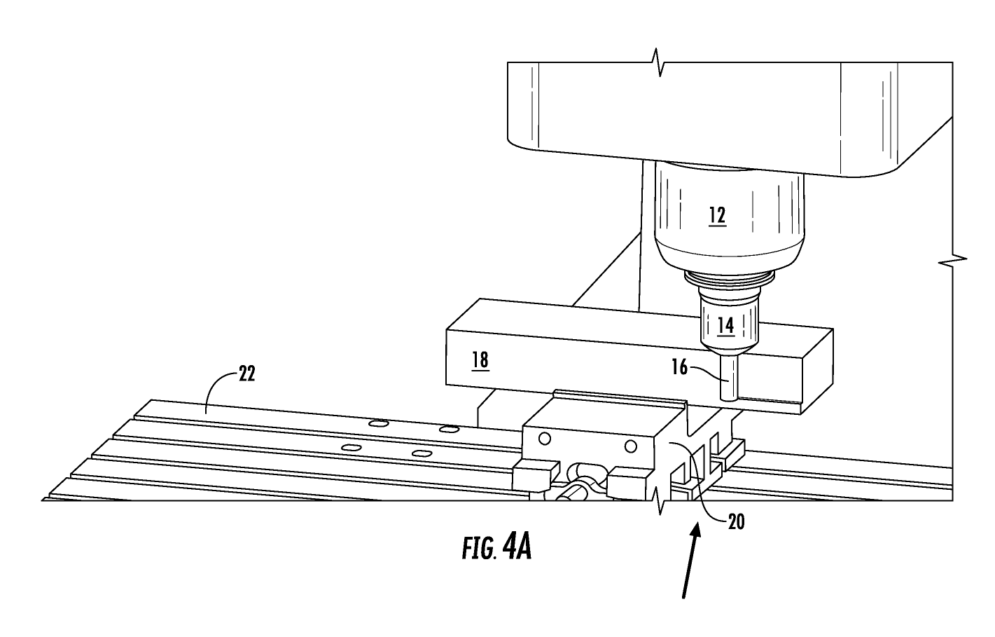

As further seen in reference to FIG. 4A, the use of a static direction coolant or air delivery system (arrow) that may be effective in one orientation, becomes ineffective when the cutting tool is positioned behind the substrate as seen in view 4B. When using a static position coolant or air line, at some point during the CNC cutting process, the cutting tool will not receive adequate air or coolant flow which results in a variety of problems that shorten the cutting tool life and can lead to expensive damage to the substrate.

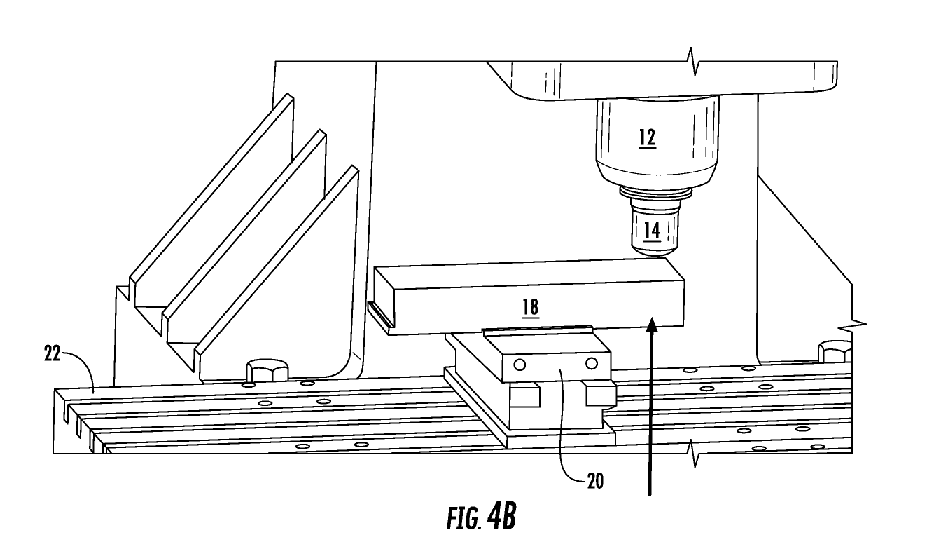

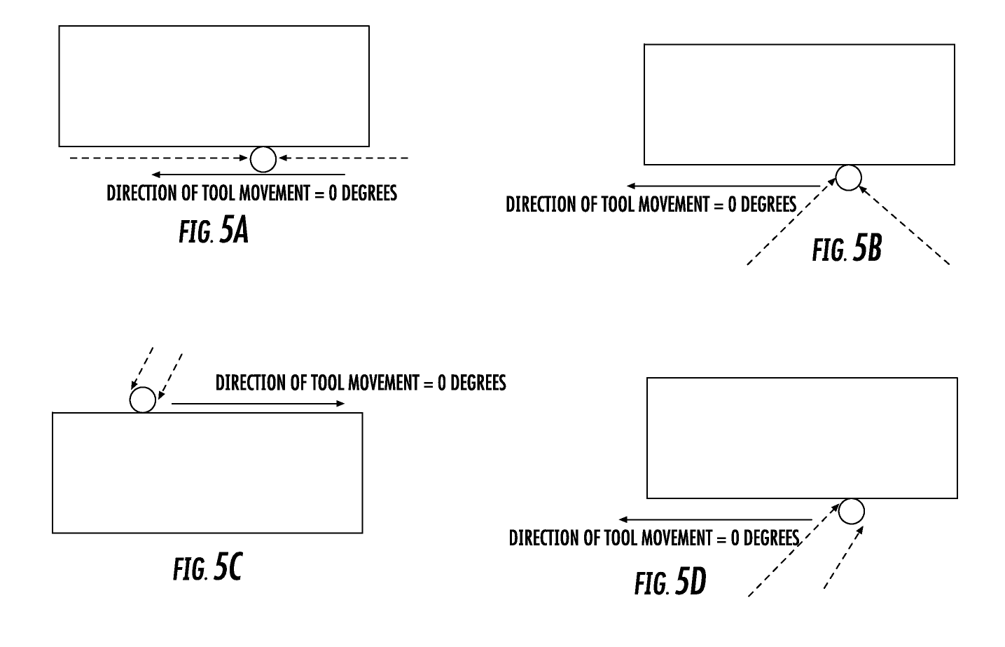

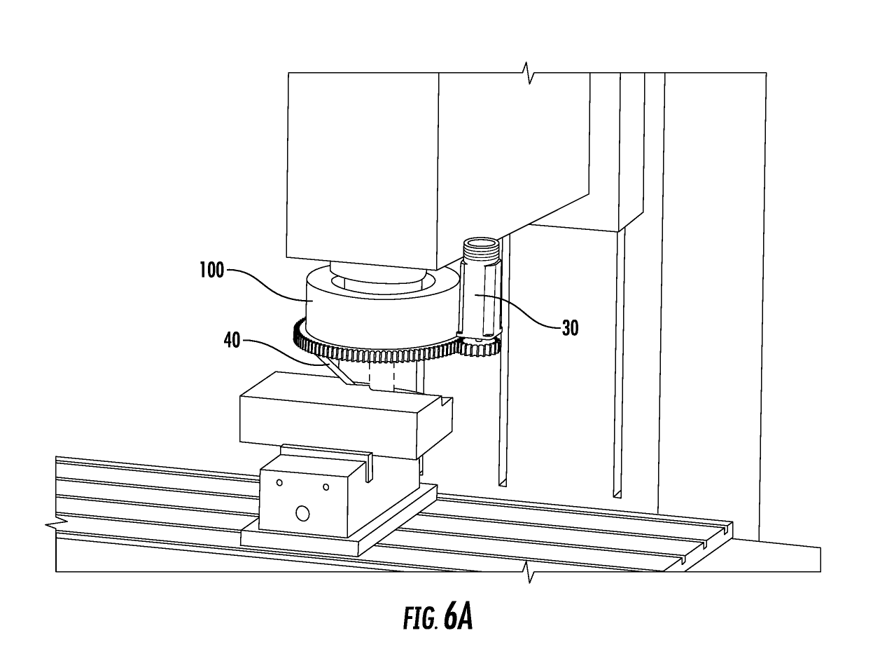

As set forth in FIG. 5A, one disadvantage of fixed direction airflow is that at times the air flow is parallel to the face of the substrate 10. This orientation will frequently result in cut chips from the substrate being blown back into the cutting tool and can damage the cutting tool edge as the tool engages and “re-cuts” the chips.

As further seen in reference to FIGS. 5B-C, improved configurations of an airflow for cooling, and which help with chip removal, are shown with respect to the cutting tool cutting the substrate.

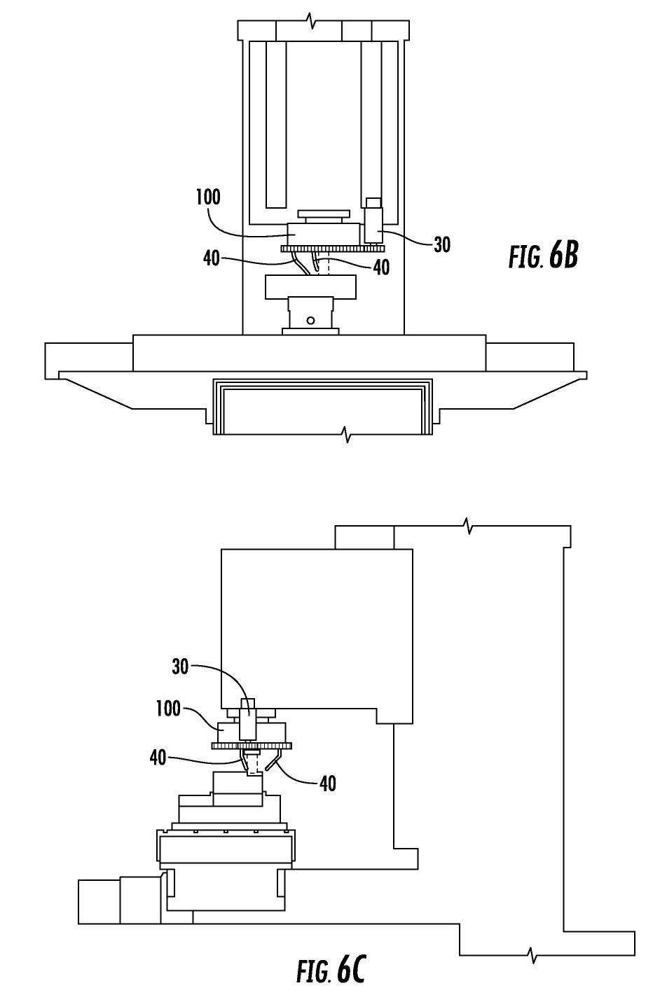

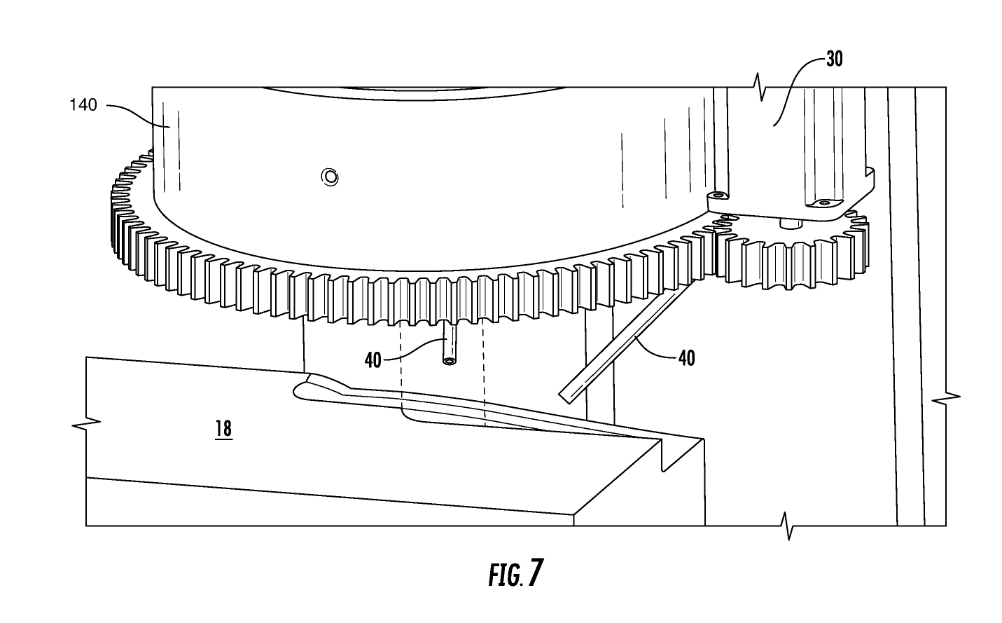

As set forth in FIGS. 6A-6C and FIG. 7, embodiments of a servo controlled motor 30 are set forth in which the servo controlled motor 30 is used to direct the movement, location, pressure and speed of one or more air nozzles 40 that can be used to direct a desired velocity and volume of air in a desired geometry relative to the cutting tool and substrate. Motor 30 is used to engage a portion of a rotary union 100. In the illustrated embodiment, a series of interlocking teeth form a gear arrangement for directing movement of the rotary union 100. The servo motor 30 is responsive to software commands and input from the CNC machine programming and can position one or more nozzles 40 that extend from the rotary union 100 into a desired position for delivering a cooling air stream to the cutting tool. While a servo motor is illustrated, one of ordinary skill in the art would recognize that other ways of directing the movement, such as a belt and pulley system or a gearing system, may be used.

In the preferred embodiment, the servo motor 30 provides for rotation at a controlled speed and direction and allows for precise controlling of the speed and direction of an air/coolant delivery system. In accordance with the present invention, it has been found that using a customized air/coolant delivery system is beneficial in that the direction of air flow, relative to the cutting tool direction of engagement, allows for improved removal of cut chips, and provides a more consistent temperature regulation of the substrate and the cutting tool blade.

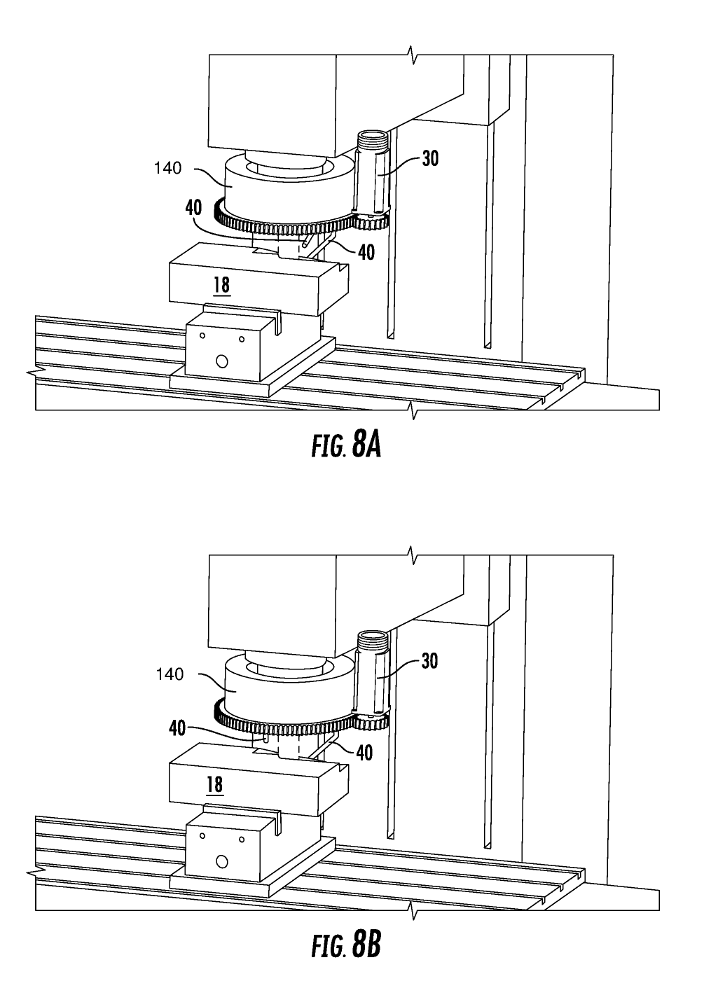

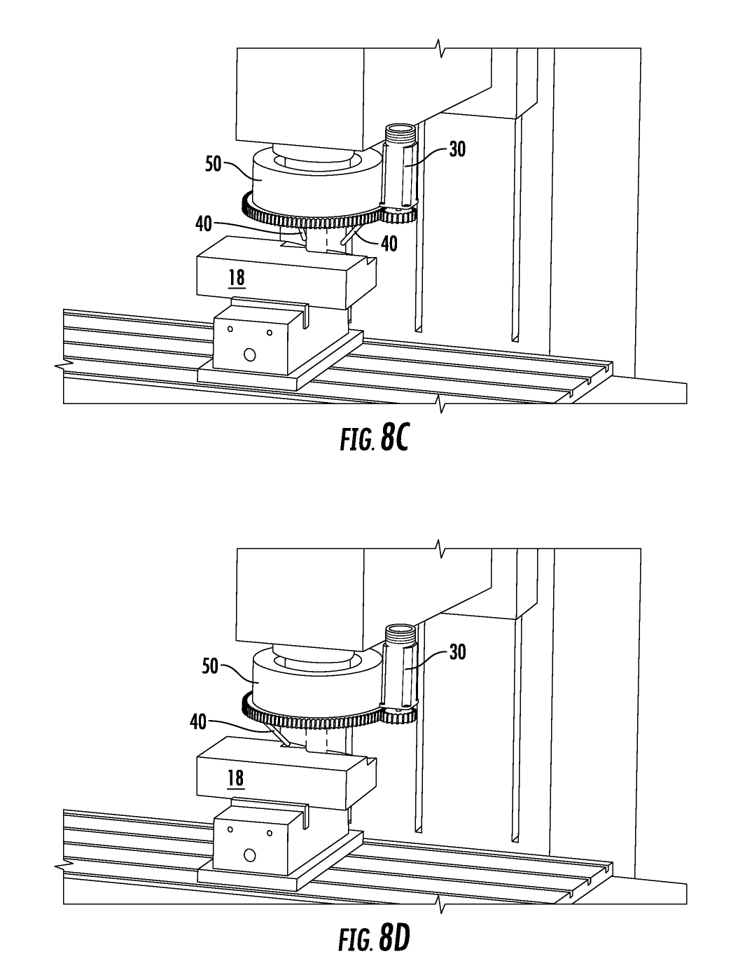

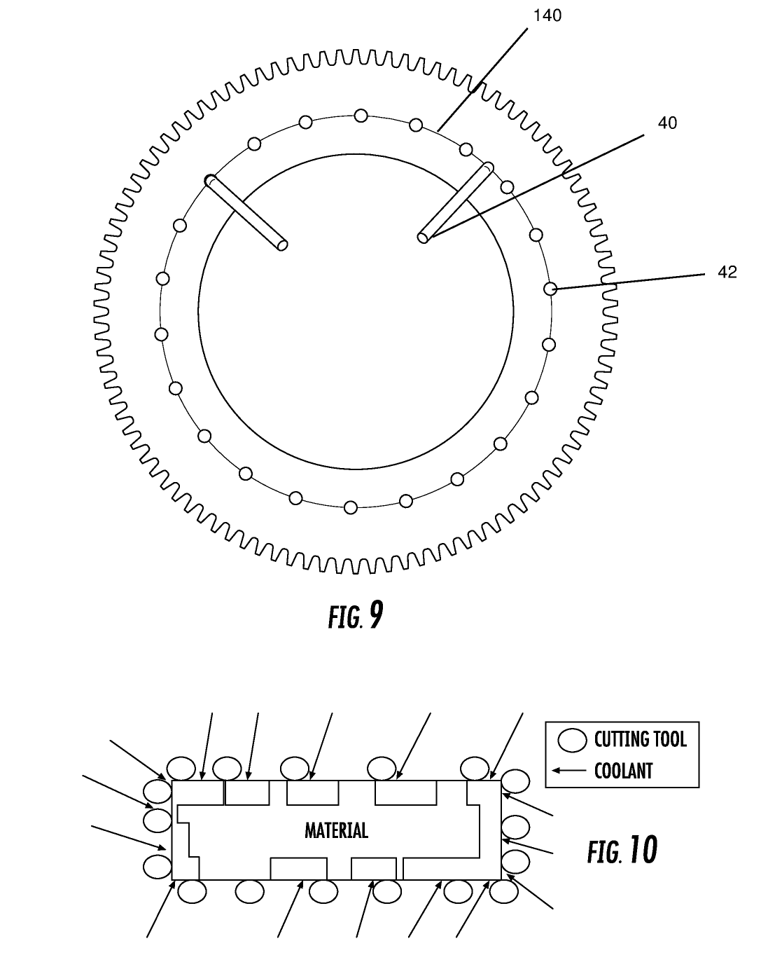

As seen in reference to FIGS. 8A-8D, a series of illustrations are set forth showing how the direction of air flow can be changed relative to the cutting tool so as to cool the cutting edge of the tool, remove chips from the tool path direction, and allows for the airlines to be controlled by the position and instructions received from a CNC program. The CNC program can be used to regulate the air on and off for each nozzle and vary the nozzle position using a rotary union apparatus in which the rotary housing portion 140 may be rotated clockwise or counter-clockwise to vary the position of one or more nozzles 40. The air/coolant delivery system can be designed to move with the cutting tool and can either track the tool or be programmed to follow the tool.

As set forth in FIG. 9, one view of a multi-port rotating air delivery apparatus is seen. A plurality of ports 42 are provided within an inner circumference of the defined air chamber 140 of the rotary union 140. As illustrated, unused ports 42 can be blocked such that only one or two nozzles 40 are in operation at any one time. The relative position of the nozzles can be adjusted and it has been found in accordance with this invention that use of two nozzles is preferred as opposed to a larger number of nozzles which requires either a higher volume and velocity of air to be delivered or results in too low of an air velocity. By using two ports, adequate air flow pressure can be delivered with minimal cost.

As seen in reference to FIG. 9, a plurality of ports 42 can be placed into the housing through which the air/coolant is supplied. It has been found useful to use two ports for the control of the air/coolant flow. The use of only one port is not as flexible and useful in terms of temperature control and chip removal and the use of more than two ports can reduce the air flow pressure being delivered to the cutting edge of the tool. While the use of three or more ports can be enhanced by increasing the available pressure and volume of a coolant, it is believed that an economical and efficient coolant delivery system can be provided using a two-nozzle system as seen in reference to FIG. 9.

The construction and design of the control system can also be influenced by the distance of the air/coolant line relative to the cutting tool and the axial position relative to the cutting tool where the air/coolant is being directed. Additionally, the amount of pressure of the air/coolant being delivered to the edge of the cutting tool can influence the beneficial properties of cooling the substrate and cutting tool as well as the effective removal of cut chips from the path of the cutting tool. By incorporating the air/coolant delivery via the CNC program further allows the ability of the program to regulate in an “on” and “off” manner the coolant flow from any given nozzle as well as to vary the volume and/or pressure of air/coolant being delivered from a nozzle based upon the position of the cutting tool, movement within the substrate, and changes in the cutting tool path.

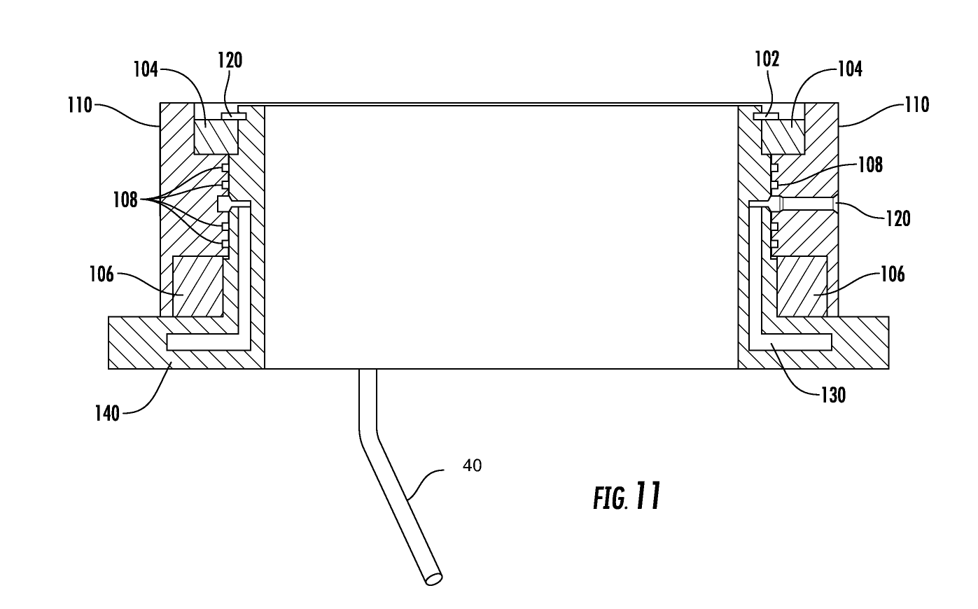

As set forth in FIG. 10, a schematic illustration of the cutting tool and the coolant air direction is provided. FIG. 10 shows the tool moving in a clockwise motion around the material. Ideally, as the tool rotates about the material substrate, the one or more nozzles associated with the coolant air is also continuously repositioned so as to maintain the desired angle and velocity of airflow. The proper volume and orientation of air flow will reduce the temperature of the tool edge, maintain a lower temperature of the material substrate, and greatly extend the useful life of the tool by avoiding repeated cycles of excessive heat followed by rapid cooling of the tool. Likewise, the material substrate being worked has an improved final quality since localized excessive heating and rapid cooling quenching was avoided during the cutting process.

As seen in reference to FIG. 11 a rotary union or swivel joint 100 may be used to provide the coolant air stream which allows the air nozzle to rotate while delivering the coolant air. As illustrated, an external stationary housing 110 defines an air inlet 120 and is in communication with an air pathway 130 defined within a portion of a rotating housing 140. Nozzle 40 is in communication with air pathway 130 and has an ability to rotate with housing 140 in order to be positioned at a desired location for delivering an air coolant stream relative to a cutting tool and a substrate.

The rotary union 100 uses retaining rings 102, top bearings 104, bottom bearings 106, and a plurality of seals 108 to allow rotation between the stationary housing 110 and the rotating housing 140. Suitable rotary unions are commercially available from Rotary Systems, Inc. (Ramsey, Minn., USA) and Dynamic Sealing Technologies. Inc. (Andover, Minn., USA).

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention as set forth herein. In addition, it should be understood that aspects of the various embodiments may be interchanged, both in whole, or in part. Therefore, the spirit and scope of the invention should not be limited to the description of the preferred versions contained therein.

That which is claimed:

1. A process of operating a CNC machine comprising the steps of:
providing a substrate to be cut;
engaging the substrate with a rotating cutting tool controlled by a CNC machine, the position of at least one of the cutting tool axis or vector direction relative to the substrate changing as the substrate is cut;
directing a stream of air from a nozzle to a leading edge of the rotary cutting tool; and
moving the nozzle in a synchronized manner relative to the movement of the cutting tool axis, thereby maintaining a continuous flow of air in a desired orientation to the cutting tool.

2. A CNC machine comprising:
a spindle;
a tool holder;
a cutting tool; and,
a rotatable housing supported by the CNC machine and in a position above the cutting tool; and
at least one nozzle extending from the rotatable housing and adapted for directing a stream of air to an edge portion of a cutting tool.

3. The process according to claim 1 wherein the step of directing a stream of air from a nozzle further includes directing a stream of air from a first nozzle and a second nozzle.

4. The process according to claim 3 comprising the additional step of varying the pressure of an air stream from at least one of the first nozzle and the second nozzle.

5. The process according to claim 4 comprising the additional step of stopping the pressure of the air flow from at least one of the first nozzle or the second nozzle.

6. A tool head assembly for a CNC machine, displaceable along orthogonal x, y, and z-axes comprising:
a support assembly;
a tool carrier assembly supported on, said support assembly having a rotatable tool axes and being displaceable relative to said support assembly;
a rotatable housing, supported by the support assembly and in a position above the tool carrier; and
at least one nozzle extending from the rotatable housing and adapted for directing a stream of air to an edge portion of a cutting tool.

7. The tool head assembly according to claim 6 wherein the rotatable housing supported on the support assembly is a rotary union.

8. The process according to claim 1 wherein said step of moving the nozzle additionally includes moving a portion of a rotary union that is in communication with the nozzle.

9. The process according to claim 1 wherein the CNC machine defines a tool head assembly according to claim 2.

10. The process according to claim 1 wherein the CNC machine defines a tool head assembly according to claim 6.
